(19) United States
(12) Patent Application Publication
(10) Pub. No.: US 2025/0123942 A1
(43) Pub. Date: Apr. 17, 2025

(54) METHODS AND SYSTEMS FOR PERFORMING APPLICATION DIAGNOSTICS VIA DISTRIBUTED TRACING WITH ENHANCED OBSERVABILITY

(71) Applicant: VMware LLC, Palo Alto, CA (US)

(72) Inventors: Arnak Poghosyan, Yerevan (AM); Ashot Nshan Harutyunyan, Yerevan (AM); George Oganesyan, Yerevan (AM); David Akhaskhalyan, Yerevan (AM); Ani Poghosyan, Yerevan (AM)

(73) Assignee: VMware LLC, Palo Alto, CA (US)

(21) Appl. No.: 18/380,348

(22) Filed: Oct. 16, 2023

(51) Int. Cl. G06F 11/34

(52) U.S. Cl. CPC G06F 11/3461

(57) ABSTRACT

Methods and systems are directed to performing application diagnostics via distributed tracing with enhanced observability. Methods are executed by an operations manager that collects spans of microservices of a distributed application executing in a cloud infrastructure. The operations manager forms traces from the spans for each request for services from the application. The operations manager reduces the dimensionality of the traces by generating a behavioral map of points in a two-dimensional space, each point represents one of the traces. The behavior map is displayed in a graphical user interface having functionalities that enables a user to investigate properties of the traces by trace type and duration and investigate of erroneous traces or clusters of traces and determine which optimization tasks to execute.

### TECHNICAL FIELD

This disclosure is directed to data centers and troubleshooting performance problems in data centers.

### BACKGROUND

Electronic computing has evolved from primitive, vacuum-tube-based computer systems to modern electronic computing systems in which large numbers of muli processor computer systems are networked together with large-capacity data-storage devices and other electronic devices in data centers that provide enormous computational bandwidths and data-storage capacities. Data centers are made possible by advances in virtualization, computer networking, distributed operating systems, data-storage appliances, computer hardware, and software technologies. The data center hardware, virtualization, abstraction of resources, data storage, and network resources combined form a cloud infrastructure that is used by organizations, such as governments and ecommerce businesses, to run applications that provide business services, web services, streaming services, and other cloud services to millions of users each day.

Cloud services have historically been provided by monolithic applications running in data centers. A monolithic application is single-tiered software in which the user interface, data processing, and data access code are implemented in a single program that is run on a single platform. Each monolithic application is self-contained and runs independent from other applications. The design philosophy was that a monolithic application performs every step needed to complete a particular function or service requested by a client. However, monolithic applications have several disadvantages. Individual components of a monolithic application cannot be changed. Any changes in the framework or language of a monolithic application often affects the entire application, which is expensive and time-consuming. A small change to a monolithic application requires redeployment of the full application.

In recent years, the software landscape has evolved away from monolithic applications to distributed applications with independent application components, called microservices. The distributed application runs in a microservices architecture composed of independently deployable microservices. Each microservice has its own logic and database and performs a single function or provides a single service. For example, streaming services that offer films and shows over the internet are run in a microservices architecture. A typical streaming service may have thousands of microservices that provide a seamless viewing experience to users. The microservices architecture has several advantages over a monolithic application. The microservices of the microservices architecture run independently. Each microservice can be separately developed, updated, deployed, and scaled up or down without affecting the other microservices. Software updates can be performed more frequently, with improved reliability, uptime, and performance.

However, distributed systems require continuous monitoring of cloud components to predict, detect and identify application performance problems before the problems affect end-users. Optimization, diagnostics, and troubleshooting of distributed applications are not feasible without machine learning (“ML”) and artificial intelligence (“AI”) empowered data analytics due to the enormous complexity of typical cloud environments. One of the key requirements for intelligent solutions is explainability and interpretability for trust and better understanding of root causes of performance problems. However, even highly explainable ML models fail to account for the full complexity of interrelations and act with the necessary level of resolution. As a result, the solutions only touch on the fragments of problems without revealing the whole picture.

### SUMMARY

Methods and systems are directed to performing application diagnostics via distributed tracing with enhanced observability. Methods are executed by an operations manager that collects spans that represent operations performed by microservices of a distributed application executing in a cloud infrastructure. The operations manager forms traces from the spans. Each trace comprising spans that represent microservices executed in response to one of the requests for a service provided by the distributed application. The operations manager reduces the dimensionality of the traces to a two-dimensional behavioral map. Each point in the behavioral map represents one of the traces. The operations manager displays the behavior map in a graphical user interface with functionalities that enables a user to investigate properties of the traces by trace type and duration and investigate performance problems with microservices and latency of microservices.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows example virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIGS. 14A-14B show an example of services of a distributed application and corresponding trace and spans.

FIG. 15 shows an example of the contents of a trace of a trace data frame stored in a trace data store.

FIG. 16 shows an example of partitioning the durations of traces stored in the trace data store into quartiles and outliers.

FIG. 17 is a flow diagram of a method for performing t-distributed stochastic neighbor embedding (“t-SNE”) for each trace in the trace data frame.

FIG. 18 shows an example plot of points in a behavior map obtained from performing t-SNE binary vectors of a set of traces.

FIG. 19 shows an example of a neighborhood of a point.

FIGS. 20A-20C show examples of a core point, a border point, and noise, respectively.

FIG. 21 shows an example of a density reachable point.

FIG. 22 shows an example plot of three clusters.

FIG. 23 shows an example of a graphical user interface (“GUI”) that displays a behavioral map of traces of an example application running in a cloud infrastructure.

FIG. 24 shows the GUI with counts of the number of traces in each cluster and the corresponding average duration of the traces in each cluster.

FIG. 25 shows the GUI with the mouse cursor positioned to reveal root spans of cluster of traces in a behavioral map.

FIG. 26 shows an example of input and output of an XGBoost model used for local and global root cause analysis (“RCA”).

FIGS. 27A-27B show the GUI used to perform global and local RCA for an application.

FIG. 28 shows an example of input and output of an XGBoost model used for identification of spans of traces outlier latencies.

FIG. 29 shows the GUI used to perform latency-base RCA for an application.

FIG. 30 shows the GUI used to display important spans of latent traces of an application.

FIG. 31 shows the GUI used to display important spans broken down by low, normal, and high latencies.

### DETAILED DESCRIPTION

This disclosure presents automated methods and systems for performing application diagnostics via distributed tracing with enhanced observability in a distributed computing system. In a first subsection, computer hardware, complex computational systems, and virtualization are described. Methods and systems are described below in a second subsection.

### Computer Hardware, Complex Computational Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

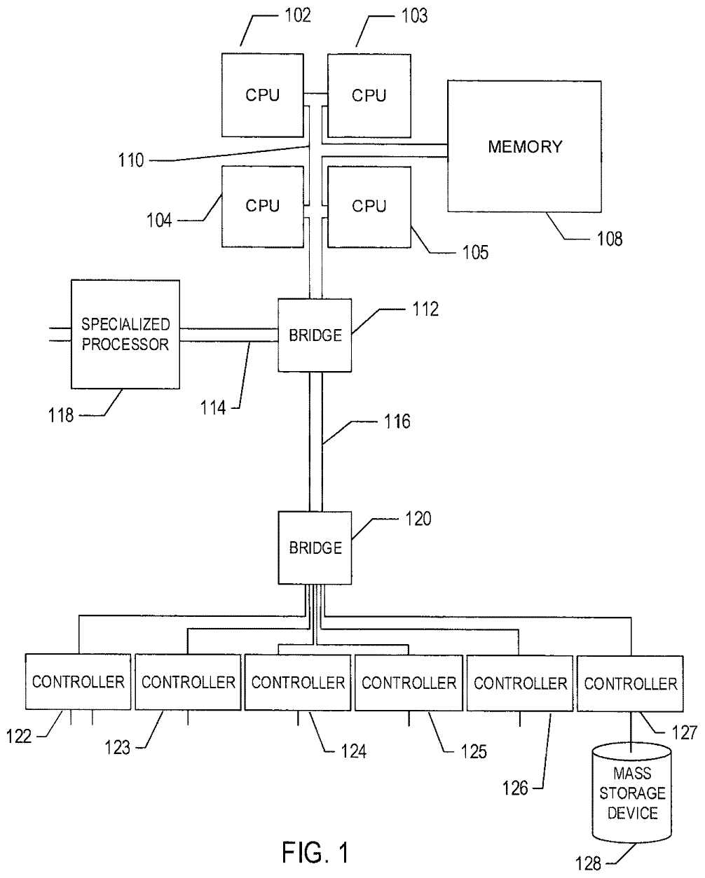

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

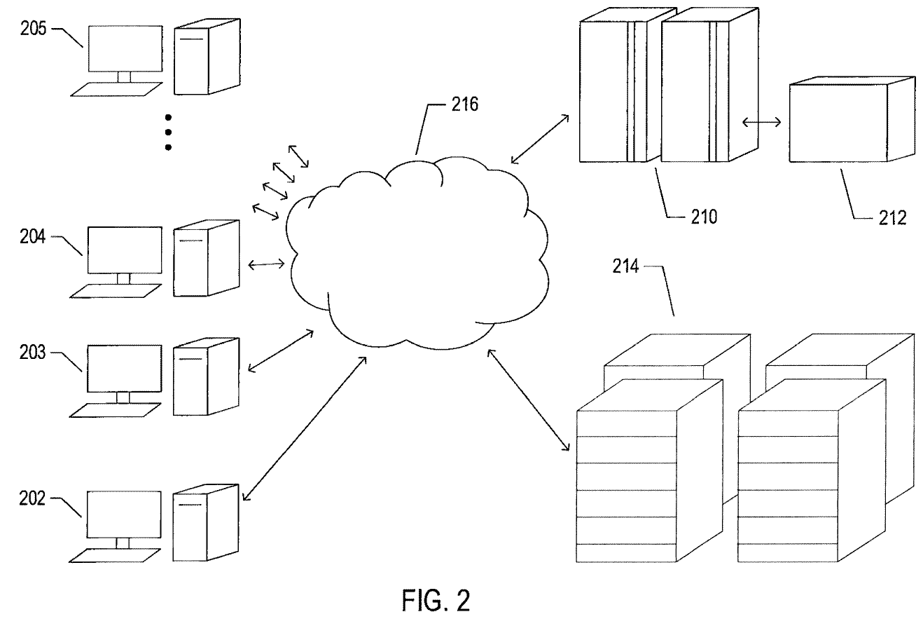

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

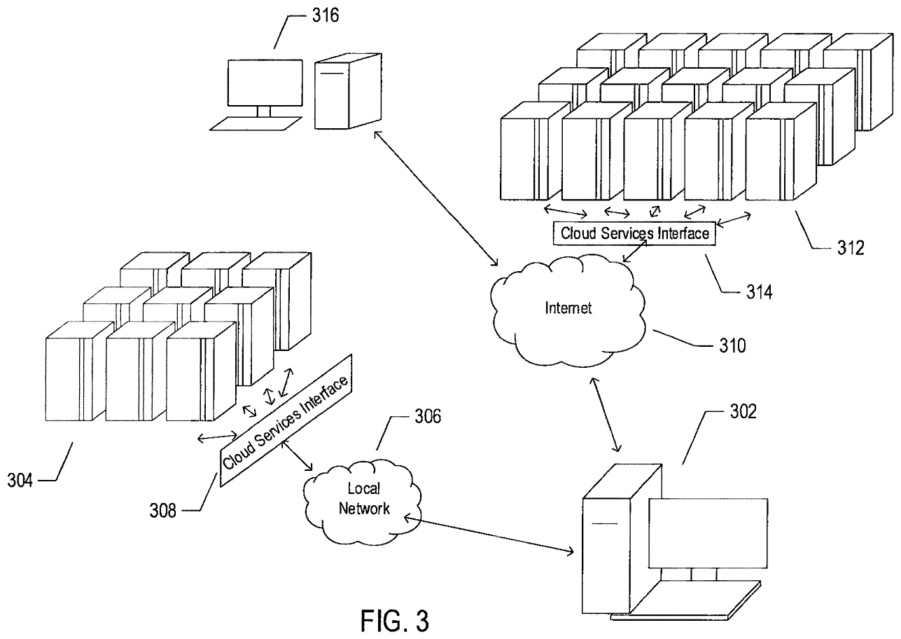

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

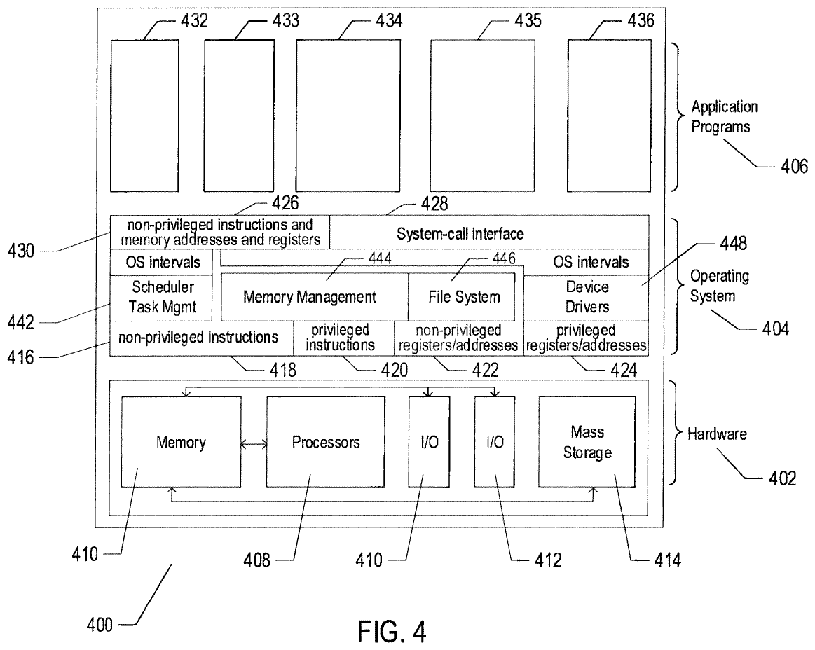

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

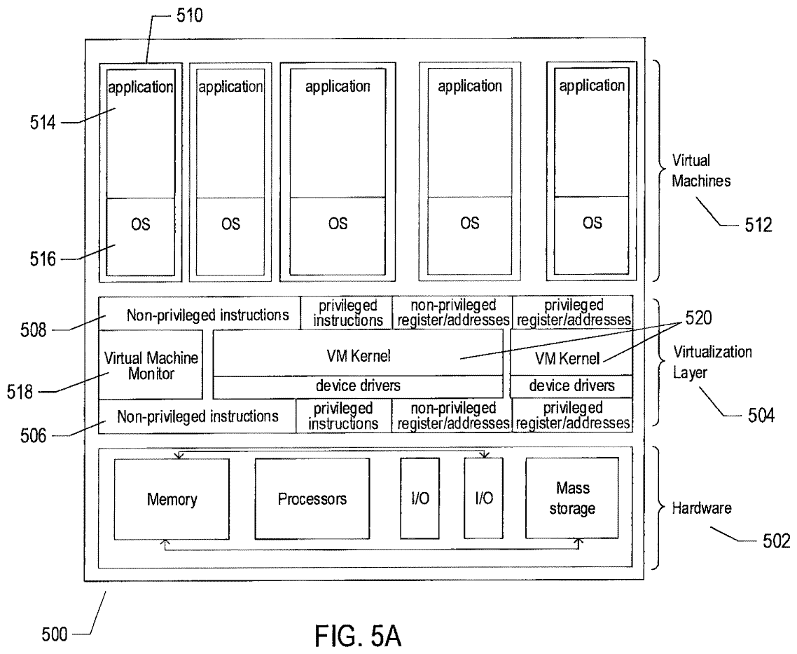

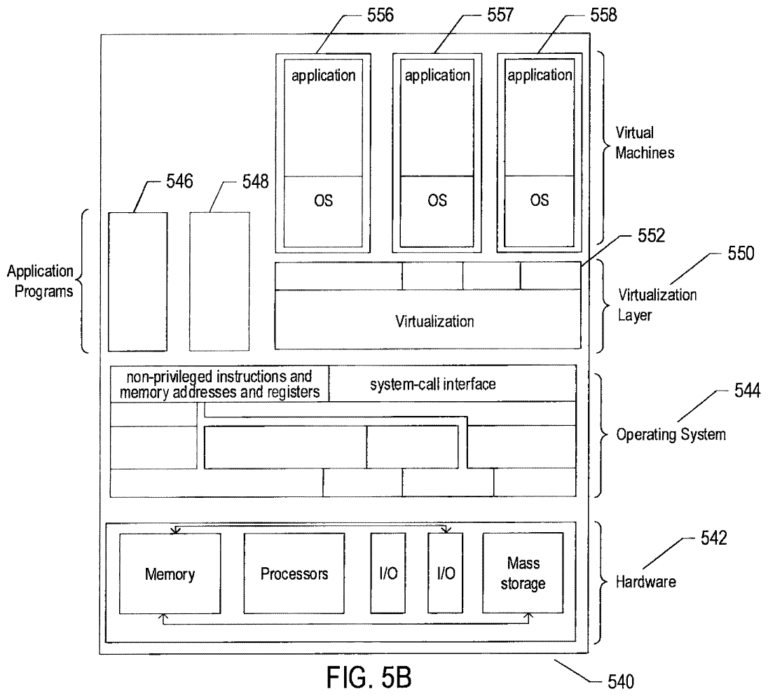

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-laver hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the genera purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 513, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

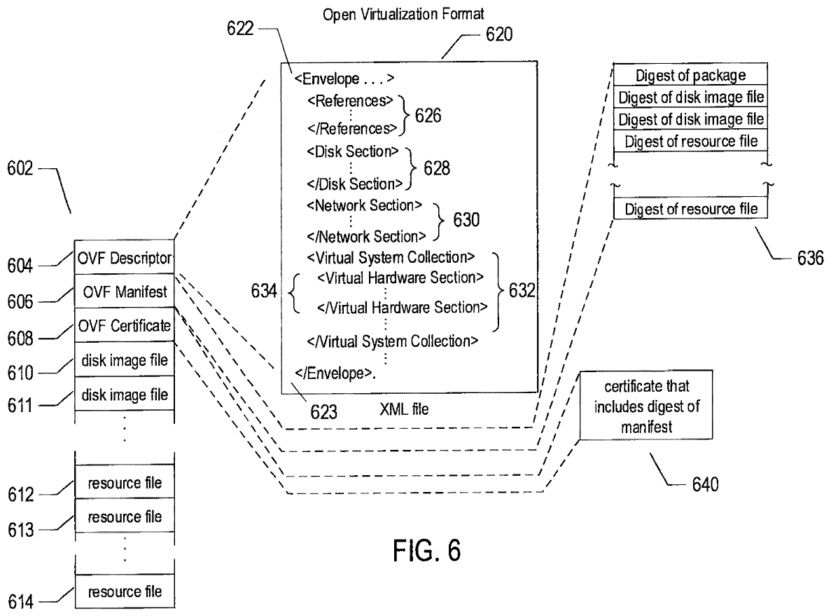

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

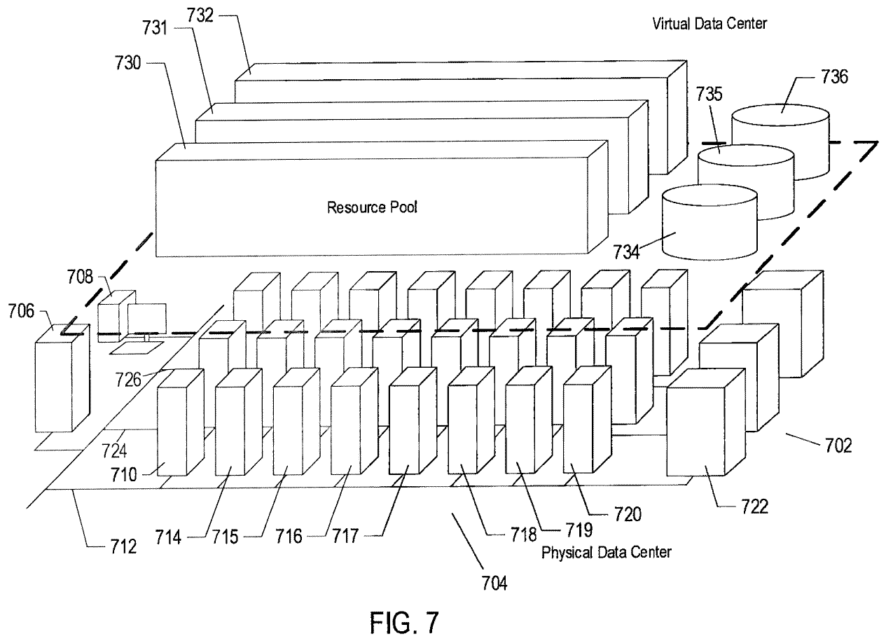

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

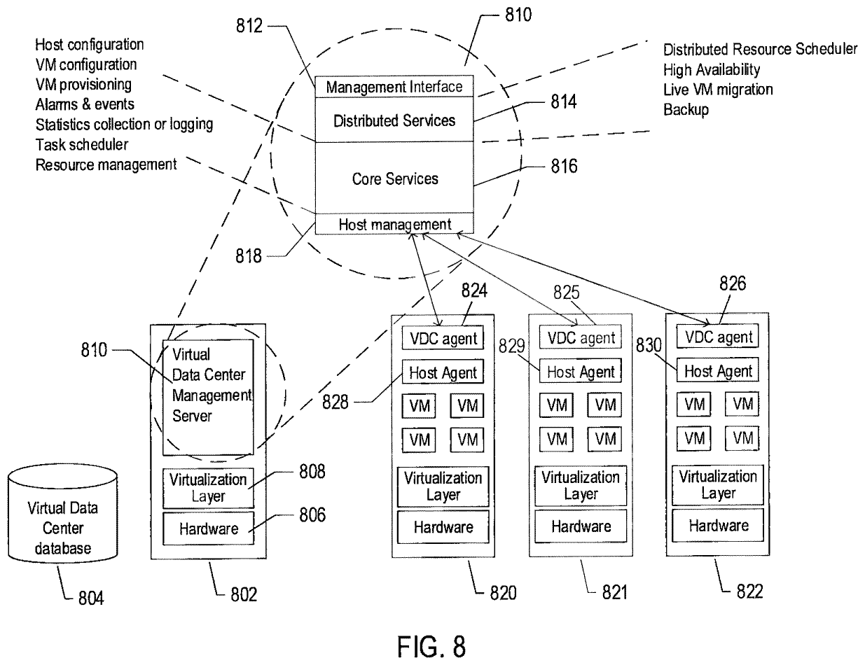

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

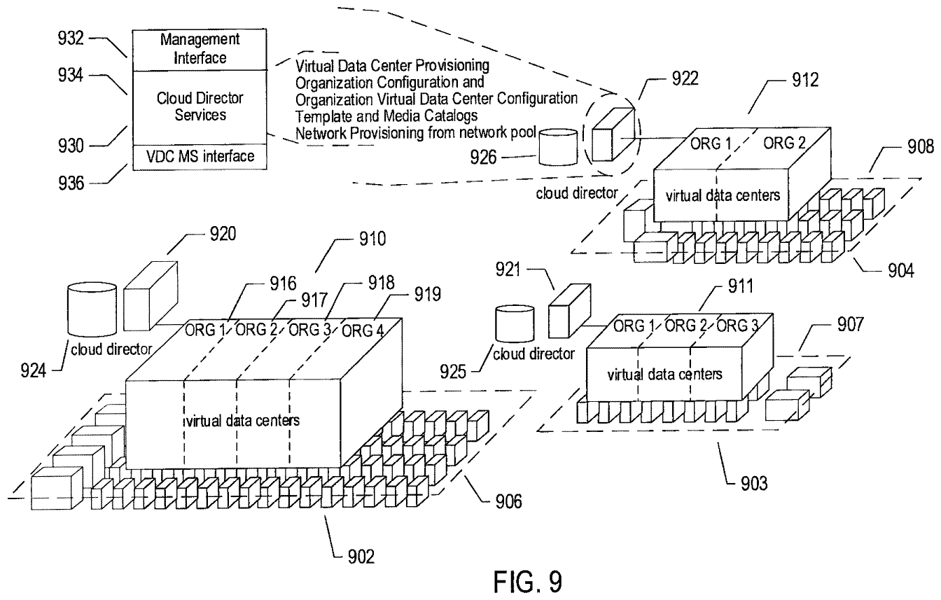

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-22 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

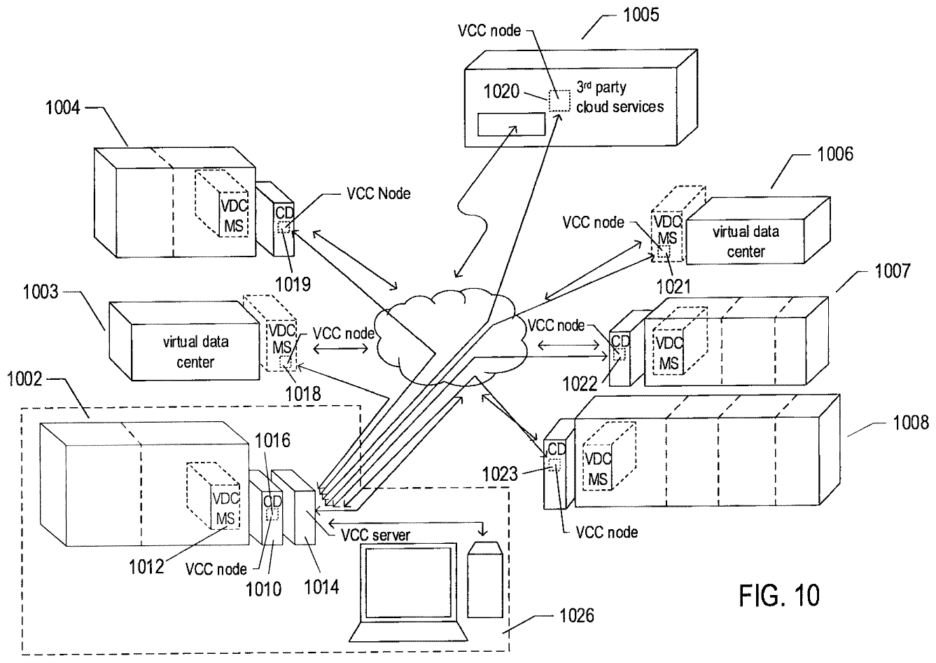

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies,

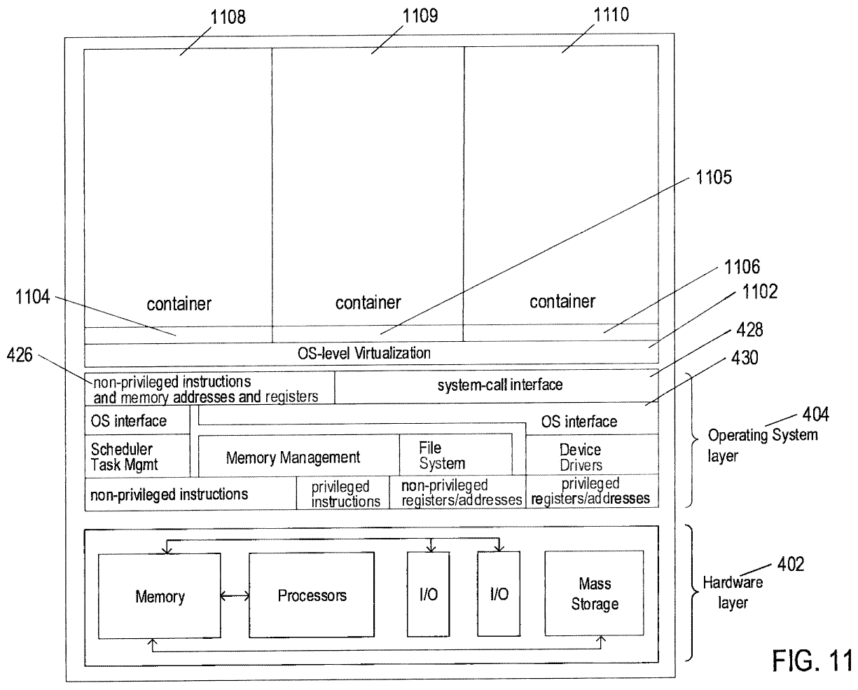

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

Methods and Systems for Application Diagnostics via Distributed Tracing with Enhanced Observability

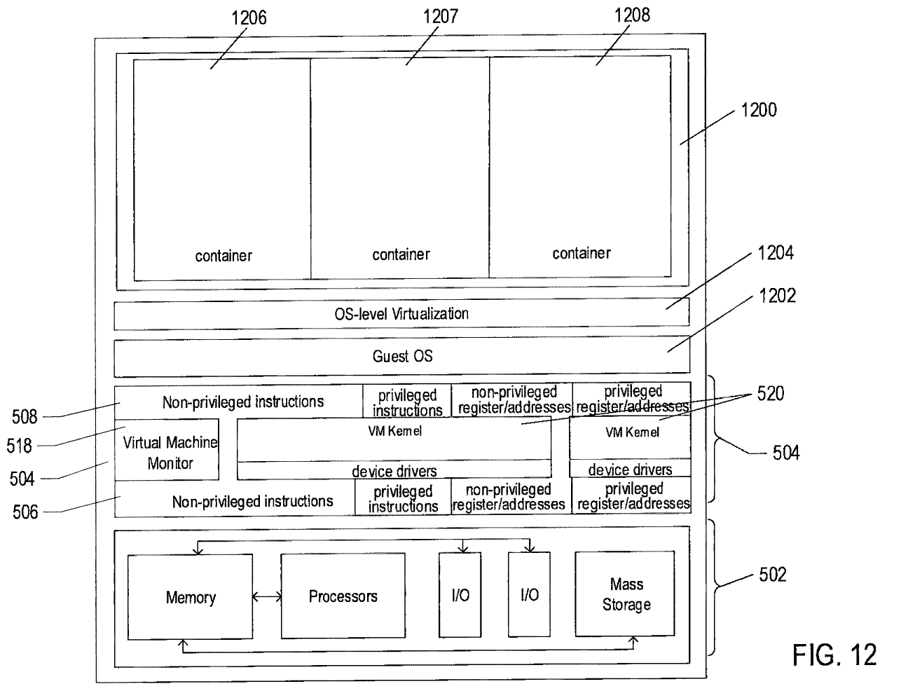

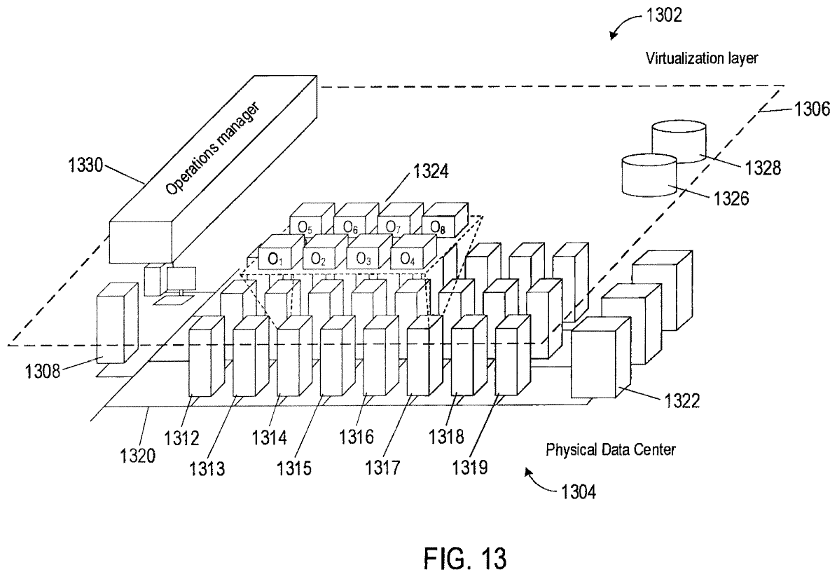

FIG. 13 shows an example of a virtualization layer 1302 located above a physical data center 1304. For the sake of illustration, the virtualization layer 1302 is show separate from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual-data-center (“VDC”) management interface may be displayed on a display device to system administrators and other users, server computers, such as server computers 1312-1319, data-storage devices, and network devices. Each server computer may have multiple network interface cards (“NICs”) to provide high bandwidth and networking to other server computers and data storage devices. The server computers may be networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects in the virtualization layer 1302. Different physical data centers may include many different types of computers, networks, data-storage systems, and devices connected according to many different types of connection topologies.

The virtual-interface plane 1306 abstracts the resources of the physical data center 1304 to virtual objects and one or more virtual data stores, such as virtual data stores 1328 and 1330. A virtual object can be a VM or a container hosted by a server computer in the physical data center 1304. The virtualization layer 1302 may also include a virtual network (not illustrated) of virtual switches, routers, load balancers, and NICs. In this example, the virtualization layer 1302 runs a distributed application with eight microservices deployed in virtual objects denoted by O₁, O₂, O₃, O₄, O₅, O₆, O₇, and O₈ that run on the cluster of server computers 1314-1317 and virtual data stores 1326 and 1328. Each virtual object runs a microservice of the distributed application.

Distributed applications, in general, provide advantages over monolithic applications. A monolithic application is implemented as a single program in which the user interface, data processing, and data access code are run on a single platform. For example, all the services of a monolithic shopping application, such as displaying merchandise, payment, and inventory, are implemented in a single program. By contrast, with a distributed application, the services are performed in separate microservices (i.e., separate application components). Individual microservices can be scaled up or down depending on demand for the microservices. For example, during a sales event certain microservices of an e-commerce application running in a cloud infrastructure are increased in number to satisfy an increased number of customers purchasing goods or services from the vendor. Alternatively, when the sales event is over, the number microservices may be decreased in number to avoid idle virtual objects. Each of the microservices can also be separately upgraded to an up-to-date version without affecting the other microservices.

Each user request input to the distributed application creates a trace, which is a collection of spans that represent unique operations performed by the microservices of the application. An operations manager 1330 shown in FIG. 13 collects the spans and records the traces and other information regarding performance of the objects that execute microservices of the distributed application in a trace data store. A span represents the performance of a service executed by a microservice of the application. Each span contains tags that record the duration of the service, the operation performed, microservice ID, span ID, parent ID, user, IP address, and location of the microservice. Other tags can be an indication of an error, such as an error tag equals “True,” that indicates the microservice has executed an erroneous operation. In the following discussion, each trace is denoted by Tₘ, where m=1, . . . , M is trace index and M is number of traces. The spans of a trace are denoted by Sₙ, where n=1, . . . , N is a span index and N is the number of spans that form the trace.

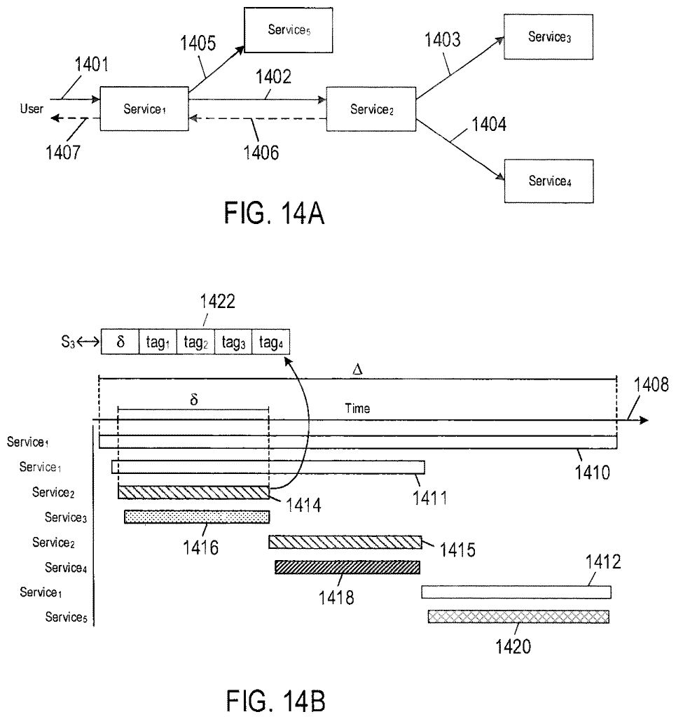

FIGS. 14A-14B show an example of services of a distributed application and a corresponding trace and spans. FIG. 14A shows an example of five services of a distributed application. The services are represented by blocks identified as Service₁, Service₂, Service₃, Service₄, and Services. The services may be web services provided to customers. For example, the application may be an e-commerce application with Service₁ a web server that enables a user to purchase items sold by the application owner. The services Service₂, Service₃, Service₄, and Services are computational services that execute operations to complete the user's request input to Service₁. The services are executed in a distributed application in which each microservice of the distributed application executes a service in a separate VM or container on different server computers or using shared resources of a resource pool provided by a cluster of server computers. Directional arrows 1401-1405 represent requests for a service provided by the services Service₁, Service₂, Service₃. Service₄, and Service₅. For example, directional arrow 1401 represents a user's request for a service, such as provided by a web site, offered by Service₁. After a request has been issued by the user, directional arrows 1403 and 1404 represent the Service₁ request for execution of services from Service₂ and Service₃. Dashed directional arrows 1406 and 1407 represent responses. For example, Service₂ sends a response to Service, indicating that the services provided by Service₃ and Service₄ have been executed. The Service₁ then requests services provided by Services, as represented by directional arrow 1405, and provides a response to the user, as represented by directional arrow 1407.

FIG. 14B shows an example trace of the services represented in FIG. 14A. Directional arrow 1408 represents a time axis. Each bar represents a span, the length of which represents the amount of time a corresponding microservice spent executing a service. The duration of Service₂ is represented by the length of the corresponding bar 1414 and is denoted by δ. The duration of the trace, denoted by Δ, represents the total amount time to complete the services in response to the user's request. The bar 1410 represents the duration of time the Service₁ spent interacting with the user. Bar 1411 represents the duration of the time Service₁ spent interacting with the services provided by Service₂. Hash marked bars 1414-1415 represent durations of time spent executing Service₂ with services Service₃ and Service₄. Shaded bar 1416 represents the duration of time spent executing Service₃. Dark hash marked bar 1418 represents the duration of time spent executing Service₄. Cross-hatched bar 1420 represents the duration of time spent executing Services. The span represented by bar 1410 is the root span of the trace. The root span occurs at the start of the trace upon the initial service request by the user and shows the total time taken to complete the user request. The terms parent span and child span are relative terms. A parent span precedes a child span and the spans correspond to a microservice that calls another microservice. The root span can be used to represent or identify the trace. FIG. 14B shows an example of tags 1422 of the span 1414. A first tag records the duration of the Service₂, δ, and includes tags additional tags tag₁, tag₂, tag₃, and tag₄ can correspond to users, resources. IP address, and location of the microservice that executes the Service₂.

The example trace in FIG. 14B is a trace that represents normal operation of the services represented in FIG. 14A. In other words, normal operations of the services represented in FIG. 14A are expected to produce a trace with similar spans and similar durations and no erroneous tags. An erroneous span has at least one erroneous tag and indicates the corresponding microservice is experiencing a performance problem. A trace is erroneous it at least one of the spans of the trace is erroneous.

The operations manager 1330 tabularizes the traces of a distributed application in a trace data frame that is stored in the trace data store. As described above, traces are composed of spans that describe the performance of individual microservices. Each row of the data frame corresponds to a trace. The columns of the data frame correspond to spans, span tags, and labels. The span columns correspond to the spans generated by microservices of the application. The span-tags columns contain the tags of spans. The labels columns contain labels for errors and labels for durations of the traces. The number of distinct spans can reach into thousands and the number of traces represented by the rows can be in the range of several hundred thousand, depending on the length of the period in which the trace data frame is recorded. The entries of the span columns are “0” or “1.” A span entry is “1” if the trace contains the span and is “0” if the trace does not contain the span. The binary values in the span columns of a trace form a binary vector in an N-dimension space. In other words, each trace has a corresponding binary vector in the N-dimension space determined by the spans of the trace.

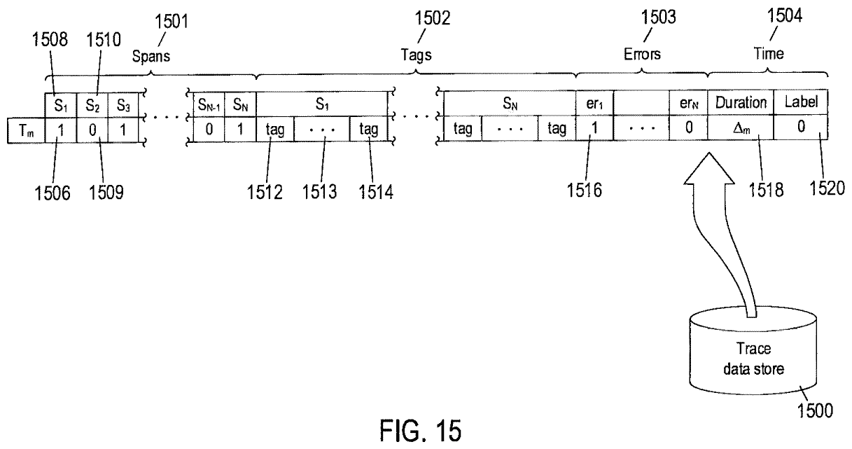

FIG. 15 shows an example of the contents of a trace Tₘ of a trace data frame stored in a trace data store 1500. The trace Tₘ includes binary values in cells of the span columns 1501, tags in the span-tags columns 1502, errors associated with the spans 1503, in error labels columns, and duration columns 1504. For example, binary value “1” 1506 indicates the trace Tₘ includes the span S₁ 1508. Binary value “0” 1509 indicates the trace Tₘ does not include the span S₂ 1510. The binary values in the cells of the spans S₁, . . . , S_{N} form the binary vector, denoted by vₘ, of the trace Tₘ in the N-dimensional space. Span-tags columns 1502 contain cells that are the tags of each span. For example, cells 1512-1514 contain the tags of the span S₁ 1508. The cells for the span S₂ 1510 are empty because the trace Tₘ does not contain the span S₂ 1510. In this example, cell 1516 of the error labels columns 1503 contains a value “1” that indicates the span S₁ is erroneous. Cells with zero entries in the remaining error labels columns 1503 indicates the spans associated with the trace Tₘ are not erroneous. Time labels columns 1504 include a cell with the duration Δₘ 1518 of the trace Tₘ and a cell with a duration label “0” 1520 that indicates the duration is normal.

The operations manager 1330 assigns a duration label to each of the traces recorded in the trace data frame based on outlier detection. A short or a long duration (i.e., low or high latency) of a trace compared to other traces can be an indication of a shift from normal behavior to a performance problem. The outlier detection identifies comparatively long and short trace durations. The operations manager 1330 partitions the distribution of trace durations into quartiles, where q₂ denotes the median of all the durations, q₁ denotes a lower median of the durations less than the median q₂, and q₃ denotes an upper median of the durations greater than the median q₂. The medians q₁, q₂, and q₃ partition the range of duration values into quartiles such that 25% of the durations are greater than q₃, 25% of the durations are less than q₁, 25% of the durations lie between q₁ and q₂, and 25% of the values lies between q₂ and q₃. Fifty percent of the values lie in the interquartile range:

$$IQR = {q}_{3} - {q}_{1} \qquad ( 1 )$$

The interquartile range is used to compute a whisker minimum given by

$${q}_{0} = {q}_{1} - B \times IQR \qquad ( 2 a )$$

and a whisker maximum given by

$${q}_{4} = {q}_{3} + B \times IQR \qquad ( 2 b )$$

where B is a constant greater than 1 (e.g., B=1.5). The whisker minimum and the whisker maximum define a range of normal or acceptable values for the durations of the traces in the trace data table. A trace duration. A, that satisfies either of the following conditions is an outlier:

$$Δ \leq {q}_{1} - B \times IQR \qquad ( 3 a )$$

$$Δ \geq {q}_{3} + B \times IQR \qquad ( 3 b )$$

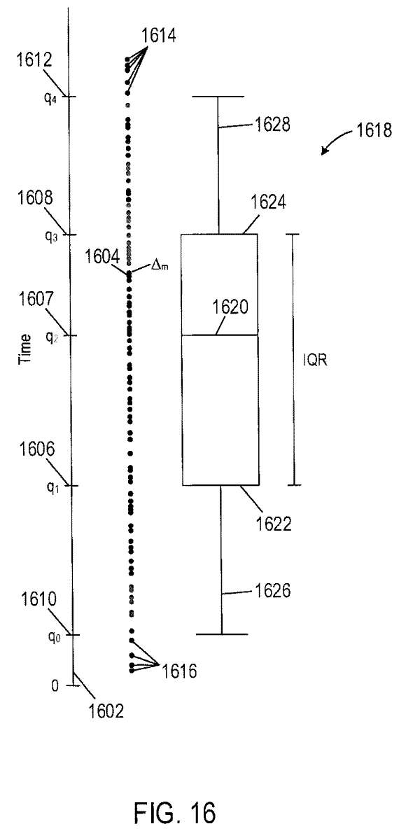

FIG. 16 shows an example of partitioning the durations of the traces stored in the trace data store 1500 into quartiles and identification of outliers. Vertical axis 1602 is a time axis. Solid dots represent durations of the traces in the trace data store 1500. For example, solid dot 1604 represents the duration Δₘ of the trace Tₘ in FIG. 15. Marks 1606-1608 along the time axis 1602 correspond to the medians q₁, q₂, and q₃ of the durations. Marks 1610 and 1612 along the time axis correspond to the whisker minimum and whisker maximum computed according to Equations (2a) and (2b). In this example, solid dots 1614 and 1616 are outliers. FIG. 16 includes a box plot 1618 that represents the spread, or distribution, of durations in the quartiles and outliers. Line 1620 corresponds to the median q₂ of the durations. Sides 1622 and 1624 of the box correspond to lower median q₁ and upper median q₃, respectively. Lengths of whiskers 1626 and 1628 correspond to the whisker maximum and whisker minimum values that define the limits of the normal range of durations of the traces in the trace data store 1500.

The operations manager 1330 assigns duration labels to the traces in the trace data store 1500. For example, the operations manager 1330 assigns traces with outlier durations greater than the whisker maximum the label 1, assigns traces with outlier durations less than the whisker minimum the label −1, and assigns traces with durations in the normal range of durations the label 0. In FIG. 15, the trace Tₘ is assigned the label 0 in cell 1520.

The operations manager 1330 projects the binary vectors of the traces to a two-dimensional behavioral map using t-distributed stochastic neighbor embedding (“t-SNE”). For the traces Tᵢ, where i=1 . . . , M, in the trace data frame, t-SNE computes probabilities pᵢⱼ that are proportional to the similarity of the binary vectors vᵢ and vⱼ of the traces Tᵢ and Tⱼ.

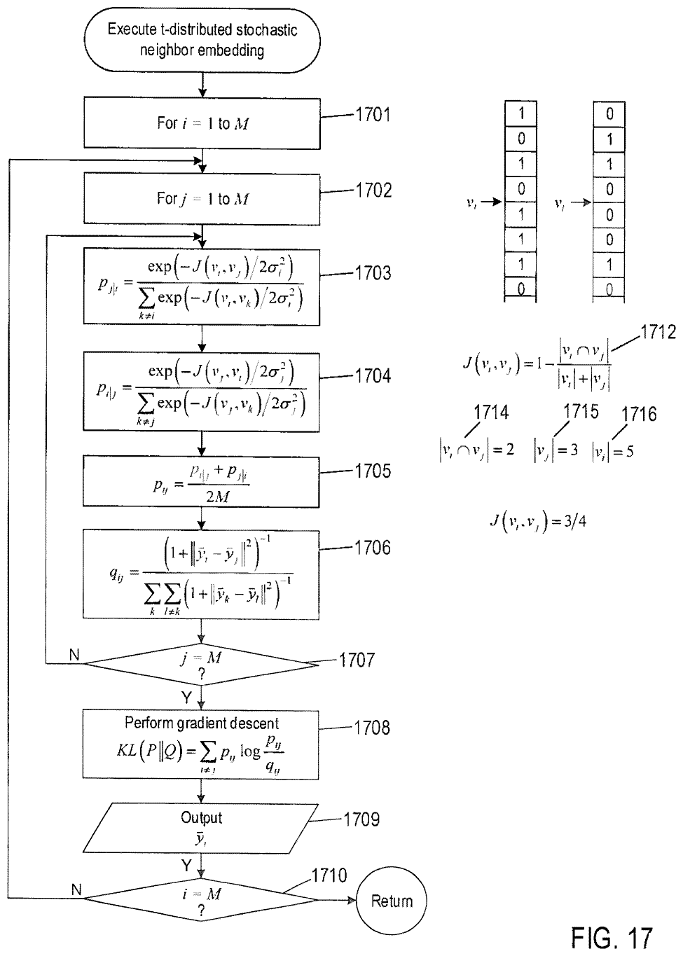

FIG. 17 is a flow diagram of a method for performing t-SNE for each of the M traces in the trace data frame. A loop beginning with block 1701 repeats the computational operations represented by blocks 1702-1710 for each of the traces. A loop beginning with block 1702 repeats the computational operations represented by blocks 1703-1716 for each of the traces. In block 1703, a conditional probability p_{i|j} is computed as represented in block 1703. In block 1704, a conditional probability p_{j|i} is computed as represented in block 1704. The conditional probabilities p_{i|j} and p_{j|i} depend on the Jaccard distance between two binary vectors. FIG. 17 includes a definition of the Jaccard distance 1712 and example computation of the Jaccard distance for two example binary vectors. The symbol |·| represents a count of the binary values “1” The numerator 1714 is a count of the number of corresponding entries of the binary vectors vᵢ and vⱼ with the binary value “1.” The quantity 1715 and 1716 are counts of the number of binary values “1” in each of the binary vectors vᵢ and vⱼ. In this example, the Jaccard distance is ¼. In block 1705, the similarity probability pᵢⱼ is computed from the conditional probabilities computed in the blocks 1703 and 1704. The t-SNE learns a two-dimensional behavioral map of points y̅₁, . . . , y̅_{M}, where y̅ₘ ∈R², that correspond to the binary vectors of the traces T₁, . . . , T_{M}. Similarities between any two points y̅ᵢ and y̅ⱼ in the behavioral map as represented in block 1706. In decision block 1707, when j=M control flows to block 1708. Otherwise, the computational operations represented by blocks 1703-1706 are repeated. In block 1708, gradient descent is performed on the Kullback-Leibler divergence of the distributions {pᵢⱼ}ⱼ₌₁^{M} and {qᵢⱼ}ⱼ₌₁^{M} to output the point y̅ᵢ 1709 of the behavioral map. In decision block 1710, the operations represented by blocks 1702-1709 are repeated until i=M.

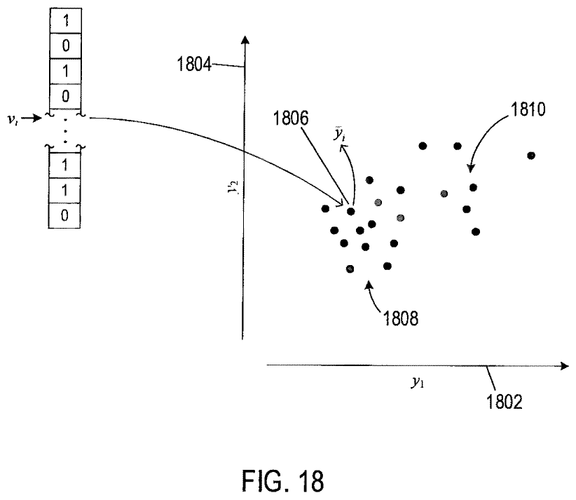

FIG. 18 shows an example plot of points in a behavior map obtained from performing t-SNE binary vectors of a set of traces. Horizontal axis 1802 represents a range of values for the coordinate y₁. Vertical axis 1804 represents a range of values for the coordinate y₂. Solid points represent points in the behavior map. For example, t-SNE maps the binary vector vᵢ of the trace Tᵢ to the point y̅ᵢ 1806. In other words, each point in the two-dimensional behavior map represents a trace. FIG. 18 also shows examples of points that form clusters 1808 and 1810 in the behavioral map.

Clusters of points in a behavior map correspond to different types of traces. The number of clusters characterizes the application in terms of the diversity of operations. The more clusters the greater the diversity of operations performed by the application. The behavioral map can be used to define trace types based on the proximity of traces in the behavioral map. Traces are also defined in terms of the root span. Similar types of traces appear in the same cluster and often have the same root spans. Clusters may also have traces with different span compositions. Behavioral maps can help prioritize optimization tasks. For example, cluster labels are applied to traces that belong to the same cluster. The durations of traces of the same cluster are averaged to determine the average duration of the different types of clusters. The largest cluster with the largest average duration (or latency) can be the first candidate for optimization

The operations manager 1330 performs hierarchical density-based clustering to identify clusters of points in a behavior map. Density-based clustering is based on neighborhoods of the points in the behavioral map. The neighborhood of a point y̅ₘ is defined by

$${N}_{ϵ} ( {\vec{y}}_{m} ) = \{ \vec{y} ∈ C \vert dist ( {\vec{y}}_{m} , {\vec{y}}_{i} ) \leq ϵ \} \qquad ( 4 )$$

where dist(y̅ₘ, y̅ᵢ) represent the Euclidean distance in two-dimensions. The number of points in a neighborhood of a point is given by |N_{∈}(y̅ₘ)|, where |·| denotes cardinality of a set.

A point is identified as a core point of a cluster of point, an edge point of a cluster of points, or a noise point based on the number of points that lie within the neighborhood of the point. Let MinPts represent a user selected minimum number of points for a core point. A point y̅ₘ is a core point of a cluster of points when |N_{∈}(y̅ₘ)|≥MinPts. A point y̅ₘ is a border point of a cluster of points when MinPts>|N_{∈}(y̅ₘ)|>1 and contain at least one core point in addition to the point y̅ₘ. A point Xₘ is noise when |N_{∈}(y̅ₘ)|=1 (i.e., when the neighborhood contains only the point y̅ₘ).

FIG. 19 shows an example ofa neighborhood of the point Xₘ denoted by the point 1902. Horizontal axis 1904 and vertical axis 1906 represent axes in a two-dimensional space. The two-dimensional neighborhood of the point. N_{∈}(y̅ₘ), is represented by a dashed circle 1908 of radius 1910 centered on the point y̅ₘ 1902. A point y̅ᵢ is an element of the neighborhood N_{∈}(y̅ₘ) if dist(y̅ₘ·y̅ᵢ)≤∈.

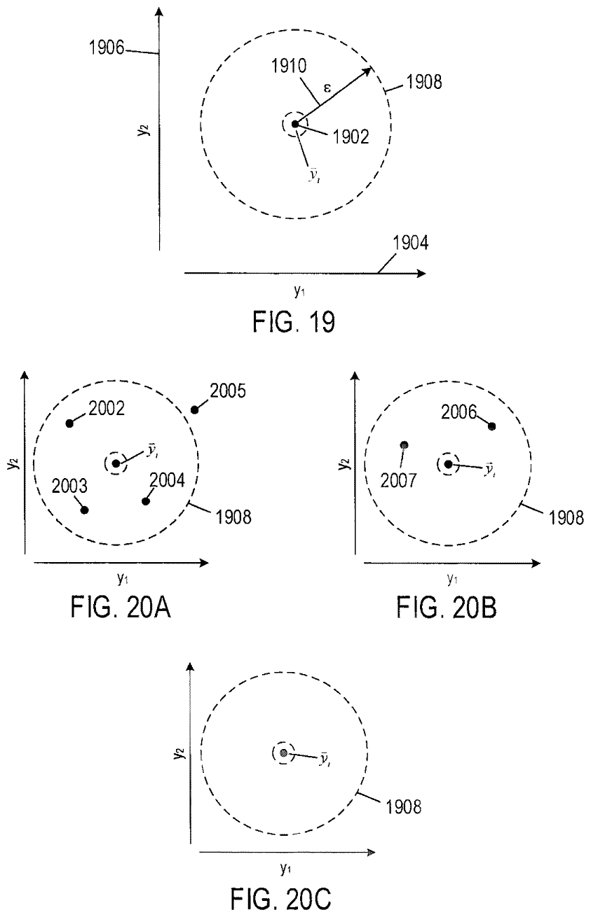

FIGS. 20A-20C show examples of the point y̅ₘ as a core point, a border point, and noise, respectively. In this example, the minimum number of points for a core point is set to 3 (i.e., MinPts=3). In FIG. 20A, points 2002-2005 represent points that are near the point y̅ₘ in the two-dimensional space. The point y̅ₘ is a core point because the three points 2002-2004 lie within the neighborhood 1908. As a result, the neighborhood 1908 contains 3 points, which is equal to MinPts. In FIG. 20B, the point y̅ₘ is a border point because the neighborhood 1908 contains the two points 2006 and 2007. In FIG. 20C, the point y̅ₘ is noise because the neighborhood 1908 contains only the single point y̅ₘ.

A point y̅ₘ is directly density-reachable from another point y̅ᵢ if 1) y̅ᵢ∈N_{∈}(y̅ₘ) and y̅ₘ is a core point (i.e., |N_{∈}(y̅ₘ)|≥MinPts. In FIG. 20A, the point 2002 is directly density-reachable from the point y̅ₘ because the point 2002 lies within the neighborhood 1908 and the neighborhood contains three points.

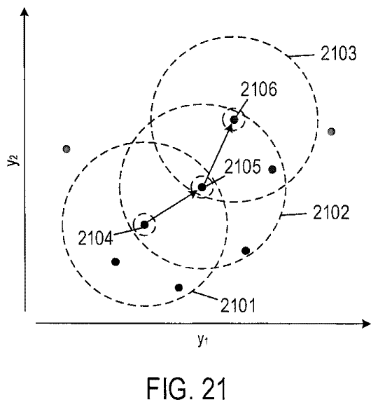

A point y̅ᵢ is density reachable from a point y̅ⱼ if there is a chain of points y̅₁, . . . , y̅ₙ, such that y̅ₖ₊₁ is directly density-reachable from y̅ₖ for k=1, . . . , n. FIG. 21 shows an example of a density reachable point. Neighborhoods 2101-2103 are centered at points 2104-2106, respectively. Point 2106 is density reachable from the point 2104 because there is an intermediate point 2105 that is directly density-reachable from the point 2104 and the point 2106 is directly density-reachable from the point 2105.

Given MinPts and the radius ∈, a cluster of points can be discovered by first arbitrarily selecting a core point as a seed and retrieving all points that are density reachable from the seed obtaining the cluster containing the seed. In other words, consider an arbitrarily selected core point. Then the set of points that are density reachable from the core point is a cluster of points. The cluster of points corresponds to a trend in similar SRs.

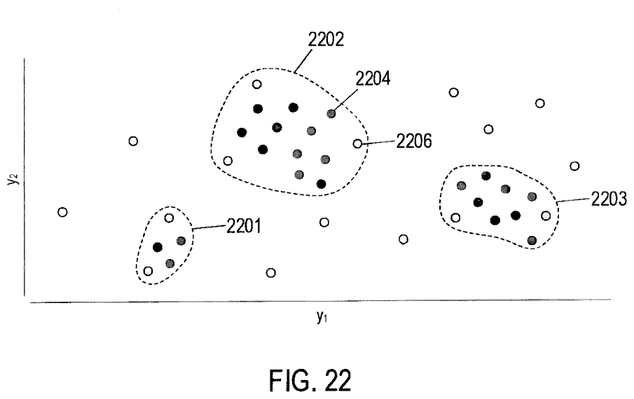

The operations manager 1330 identifies clusters of points in the behavioral map based on the minimum number of points MinPts and the radius ∈. FIG. 22 shows an example plot of three clusters of two-dimensional points 2201-2203. Each cluster contains core points identified by solid dots, such as solid dot 2204, and border points identified by gray shaded dots, such as gray shaded dot 2206. Open dots, such as open dot 2208, represent points identified as noise. For each cluster, the operations manager 1330 adds a corresponding cluster label to each of the traces in the trace data frame.

The operations manager 1330 displays the behavioral map of an application in a graphical user interface (“GUI”) of a display device. The GUI has functionalities described below that enables a user to select operations for investigating the traces by trace type and average duration. The different clusters of points of the behavioral map can be viewed in the GUI and the user can select operations that enable the user to perform a detailed investigations of the corresponding traces and determine which optimization tasks to execute.

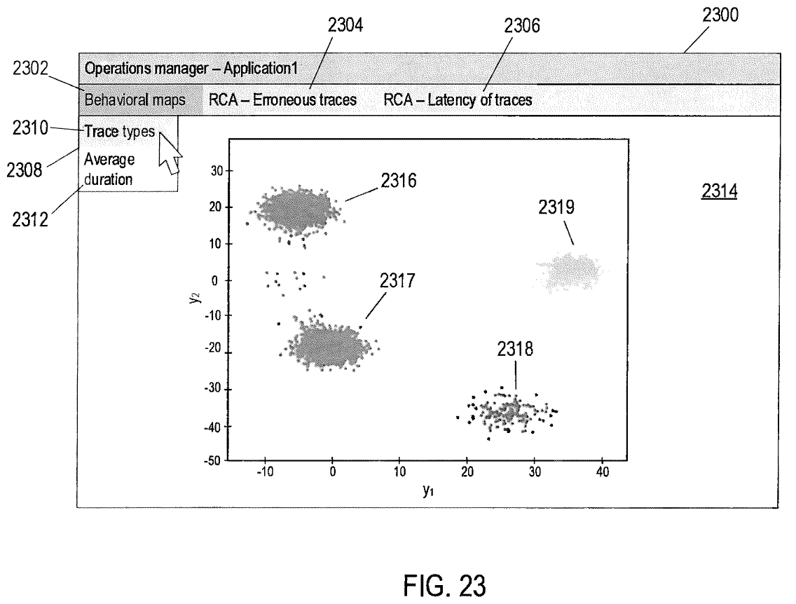

FIG. 23 shows an example of a GUI 2300 that displays the behavioral map of an example Application1. The Gi 2300 includes dropdown menus that enable a user to investigate behavioral maps 2302, RCA-Erroneous traces 2304, and RCA-Latency of traces 2306 Application1. In this example, the user has selected behavioral maps 2302 which creates a dropdown menu 2308 with options for determining trace types 2310 and average duration 2312. The user selected trace types 2310. The behavior map formed from the traces the application as described above is displayed in a pane 2314. In this example, the behavior map is composed of four distinct clusters or points 2316-2319 that correspond to four different operations of Application1. To improve visibility and distinguish the clusters, the operations manager 1330 displays each cluster with a different shading or color.

The operations manager 1330 counts the number of points in each cluster and computes an average duration (or latency) of the traces that correspond to the points in each cluster. Let C denote a cluster of points and N_{C} denote the number of points in the cluster. The average duration of the corresponding traces is given by:

$$Ave ( C ) = \frac{1}{{N}_{c}} {\sum }_{{\vec{y}}_{m} ∈ C} {Δ}_{m} \qquad ( 5 )$$

where Δₘ is the duration of the trace Tₘ with a corresponding point y̅ₘ in C. When the user selects average duration 2312 from the dropdown menu 2308 of the behavior maps 2302 in the GUI 2300, the operations manager 1330 displays the counts of the number of points in each cluster and the average durations of the corresponding traces.

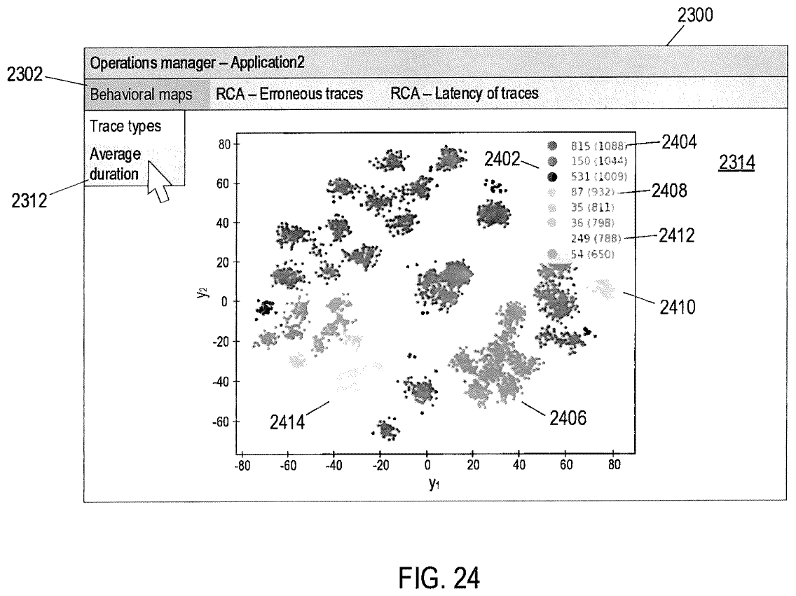

FIG. 24 shows the GUI 2300 with counts of the number of points in each cluster and the corresponding average duration of the corresponding traces for an Application2. In this example, certain clusters are distinguished by different shadings or colors. The pane 2314 includes a table 2402 with counts of the number of points in certain clusters and average durations of the corresponding traces in parentheses. For example, table entry 2404 reveals that the cluster 2406 has 815 points and the average duration is 1088 for the corresponding traces. Table entry 2408 reveals that the cluster 2410 has 87 points and the average duration is 932 for the corresponding traces. Table entry 2412 reveals that the cluster 2414 has 249 points and the average duration is 788 for the corresponding traces.

Each trace in the trace data frame has a root span that represents the trace. The operations manager 1330 enables a user to hover the mouse cursor over a cluster of points in the behavioral map to display a popup table of the root spans of the traces that form the cluster. The popup table enables a user to identify the root spans of the traces that form the cluster and determine how the traces in the same cluster are related to one another.

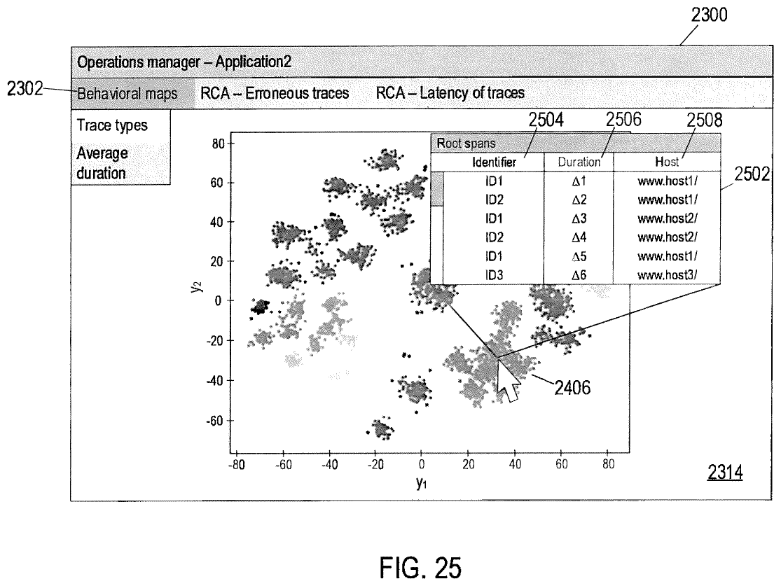

FIG. 25 shows the GUI 2300 with the mouse cursor positioned over the cluster of traces 2406. In this example, the GUI 2300 displays a popup table 2502 for the cluster 2406 with a column 2504 that list identifiers of the root spans of the traces, a column 2406 that list the corresponding durations of the root spans, and a column 2408 that list the hosts on which the microservices of the correspond root spans are executed on.

As described above with reference to FIG. 15, an erroneous trace is defined as having one or more erroneous spans. A trace is considered normal if none of the spans of the trace is erroneous. The operations manager 1330 executes global and localized RCA of the traces. With global RCA, the operations manager 1330 utilizes a trained XGBoost (“Extreme gradient boosting”) model for explanation of erroneous traces. XGBoost is an open-source software library of gradient boosted decision trees algorithm designed for speed and performance. The XGBoost model for explanation of erroneous traces is trained using traces of the application recorded in a historical period and used to detect erroneous traces produced in a current period.

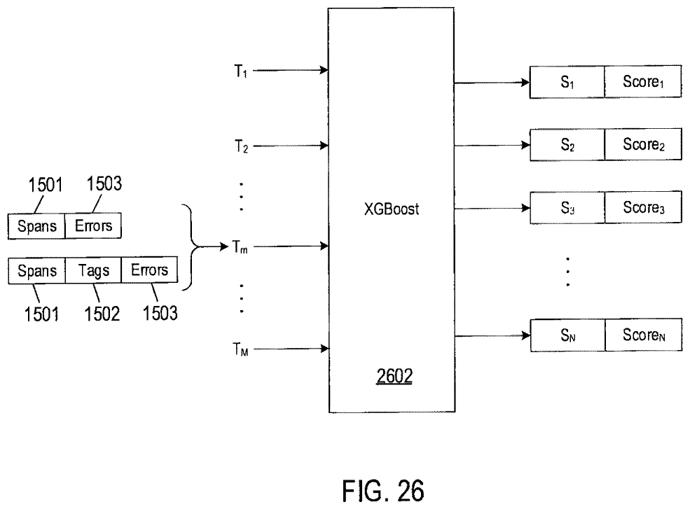

FIG. 26 shows an example of input and output of the XGBoost model used by the operations manager 1330 for local and global RCA. Block 2602 represents the XGBoost model, which receives as input the trace data frame. In a first implementation, the input is composed of the spans, or binary vectors, and corresponding error labels of the traces. For example, in the first implementation the input for the trace Tₘ is composed of the spans 1501 and error labels 1503. In a second implementation, the input is composed of the spans, or binary vectors, tags, and corresponding error labels of the traces. For example, in the second implementation the input for the trace Tₘ is composed of the spans 1501, tags 1502, and error labels 1503. The XGBoost model outputs the spans of the traces with corresponding scores denoted by Score₁, . . . , Score_{N}. The larger the score value, the greater the importance of the corresponding span.

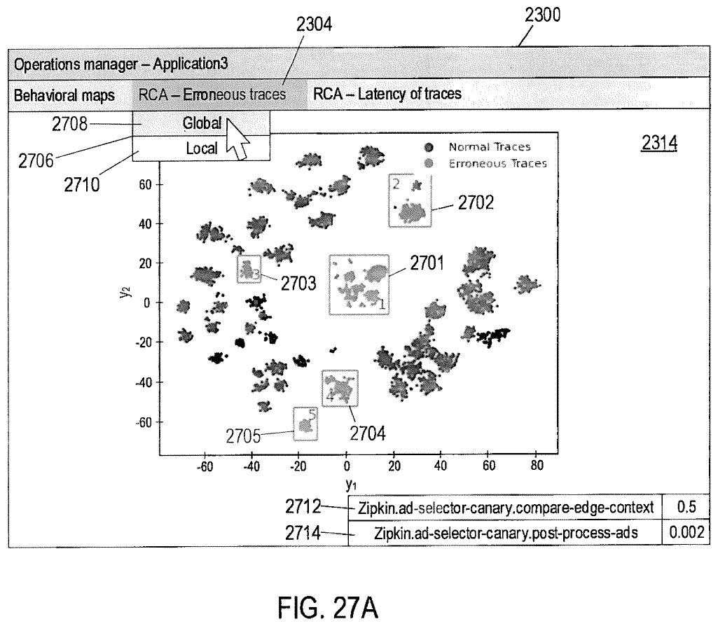

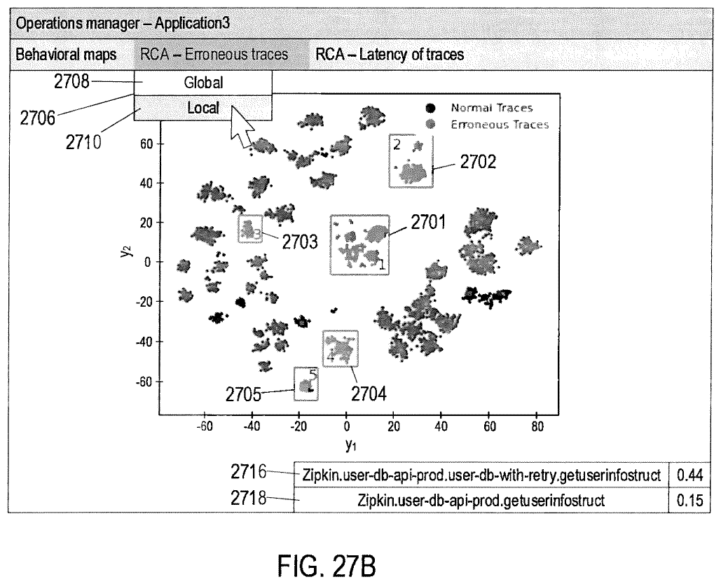

FIGS. 27A-27B show the GUI 2300 used to perform global and local RCA for an Application3 with a corresponding behavioral map shown in the pane 2314. In FIG. 27A, the user has selected RCA erroneous traces 2314. The operations manager 1330 identifies spans with erroneous tags in the trace data frame of the Application3 and identifies the corresponding points with boxes 2701-2705 and a different shading or color than the normal than the points that correspond to normal traces. Clicking on the RCA erroneous traces 2314 creates a dropdown menu 2706, which includes options for determining global error analysis 2708 and local error analysis 2710. In this example, the user has selected global error analysis and the operations manager 1330 inputs the spans and error labels of the traces of the trace data frame into XGBoost to obtain scores for each of the N spans. The IDs of the microservices 2712 and 2714 that correspond to the spans with the highest two scores are displayed in the pane 2314, thereby providing the user with information regarding which of microservices are exhibiting erroneous behavior.

In FIG. 27B, the user clicks on local error analysis 2710 in the dropdown menu 2706. The user then clicks one of the five clusters with erroneous trace. In this example, the user selects the cluster of points 2701. In response, the operations manager 1330 inputs the spans and error labels of the traces with corresponding points in the cluster 2701 into XGBoost model and inputs the spans and error labels of the traces located outside the cluster of points 2701 into the XGBoost model with the error labels switched to normal. The IDs of the microservices 2716 and 2718 that correspond to the spans with the highest two scores of the erroneous traces are displayed in the pane 2314, thereby providing the user with information regarding which of microservices associated with the erroneous traces in the cluster are exhibiting erroneous behavior.

s can also be used to identify performance degradation of an application based on the trace duration labels added to the trace data frame as described above with reference to FIG. 16. The execution time ofa service typically has an average duration. Traces and spans with extraordinarily short or long durations or latencies (i.e., outlier traces in FIG. 16) compared to other traces in the trace data frame can be investigated for optimization. The operations manager 1330 utilizes a trained XGBoost model for detection and explanation of traces with outlier durations. The operations manager 1330 trains the XGBoost model for explanation of traces with outlier durations using traces of the application recorded in a historical period.

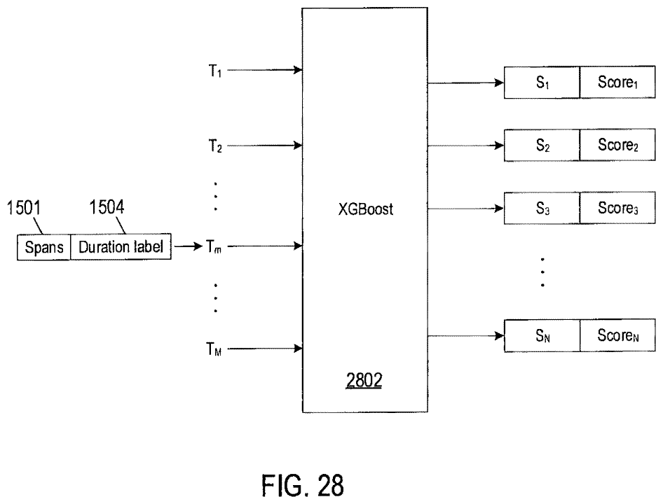

FIG. 28 shows an example of input and output of the XGBoost model trained by the operations manager 1330 for identification of spans associated with outlier durations. Block 2802 represents the XGBoost model that receives spans (i.e., binary vectors) and duration labels as input, such as the spans 1501 and duration labels 1504. The XGBoost model outputs the spans with corresponding importance scores denoted by Score₁, . . . , Score_{N}. The larger the score value, the greater the importance of the corresponding span in contributing to the outlier duration of a trace.

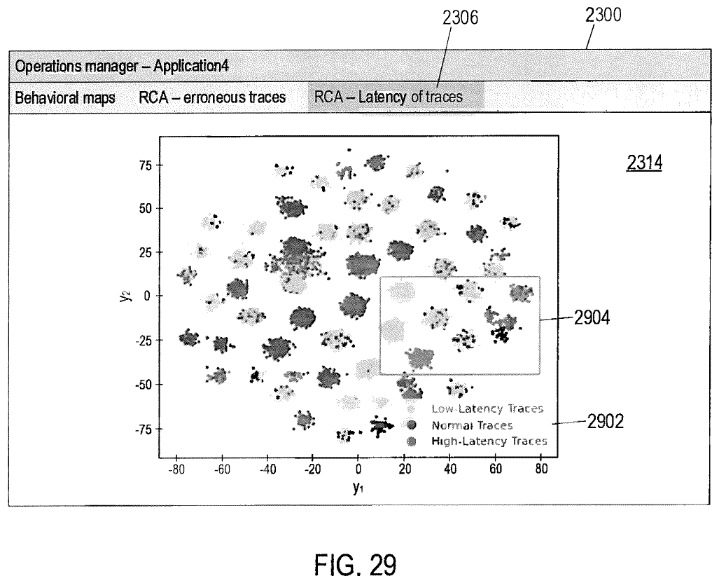

The GUI 1300 is used to display traces and the corresponding duration labels in a behavior map. FIG. 29 shows the GUI used to perform RCA of latency of traces for an Application4 with a behavioral map displayed in the pane 2314. In FIG. 29, the user has selected RCA latency traces 2306, which displays points representing the traces of the Application4 with shading or color coding to identify points that correspond to traces with low, normal, and high latencies as indicated in legend 2902. The GUI 2300 enables a user to select a group of traces to identify the importance spans. In this example, the user has outlined points with the rectangle 2904. When the user selects RCA latency of traces 2306, a dropdown menu 3002 is displayed. When the user selects importance scores 3004, the operations manager uses the XGBoost model for detection and explanation of traces with outlier durations to determine importance scores for the traces. The corresponding traces are input to the XGBoost model for detection and explanation of traces with outlier durations. The remaining traces are also input to the XGBoost model with the duration labels of traces located outside the rectangle change “0” to indicate normal trace durations.

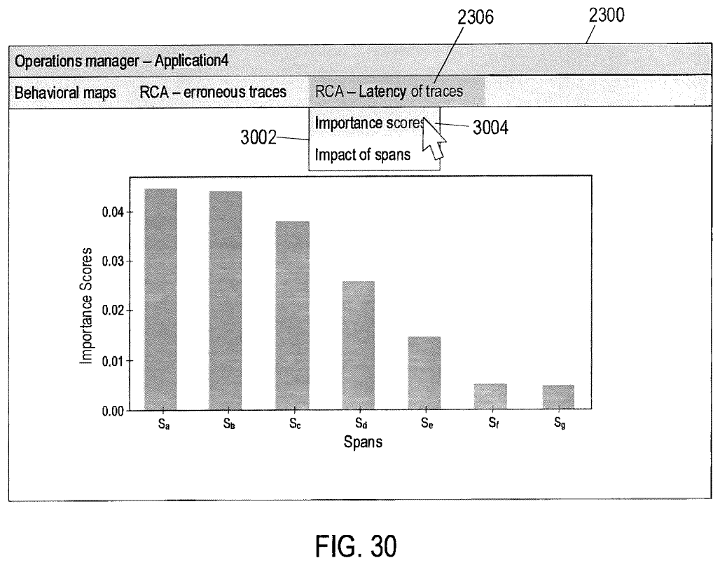

FIG. 30 shows the GUI 2300 displays a bar graph of the seven most important spans of the Application4. The scores reveal the level of importance of the corresponding microservices with high or low duration of the Application4.

FIG. 30 does not display detailed information regarding which spans correspond to short durations and which spans correspond to long durations of the traces. The operations manager 1330 executes RIPPER or SHAP algorithms to provide additional information about which spans are affecting short or durations of the traces. RIPPER is a well-known rule-based classification algorithm that derives a set of rules by repeated incremental pruning of a training set of traces. On the other hand, SHAP (“SHapley Additive exPlanations”) is a well-known algorithm that produces values that explain the output of the XGBoost model.

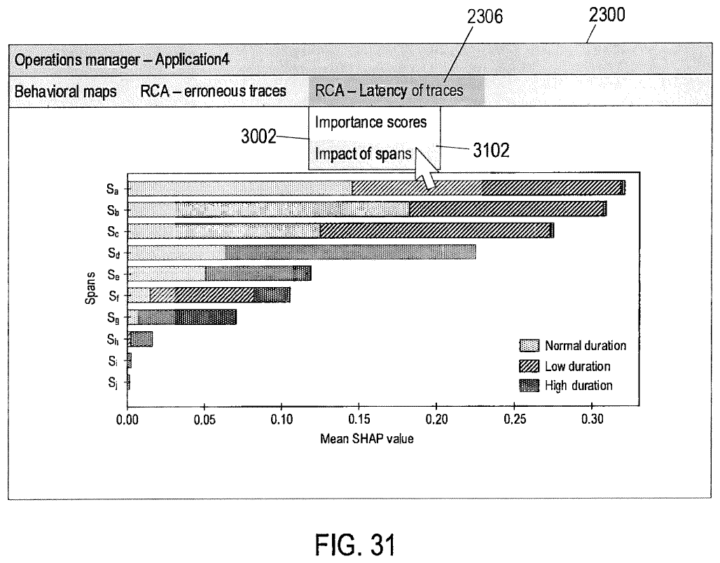

FIG. 31 shows the GUI 2300 displays a bar graph of the ten most important spans broken down by mean SHAP values in response to the user selecting impact of span 3102 in the dropdown menu 3002. The mean SHAP values indicate the average impact each of the spans has on the latency of the application. The higher the mean SHAP value the more impact the span has on the duration of the trace, which corresponds to longer processing time for the Application4.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method stored in one or more data-storage devices and executed using one or more processors of a computer system for performing diagnostics of an application executing in a cloud infrastructure, the method comprising:
collecting spans that represent operations performed by microservices of the application in response to requests for services executed by the application;
for each service executed by the application, forming a trace from the spans of the microservices that executed operations to provide the service;
projecting binary vector representations of the traces onto a behavioral map in two-dimensional space, the behavioral map having points that represent the traces in two dimensions; and
displaying a graphical user interface (“GUI”) on a display device, the GUI having a pane that displays the behavioral map and functionalities that enables a user to launch operations for investigating traces based on trace type and duration and launch machine learning models to investigate performance problems with microservices and latency of microservices.

2. The method of claim 1 wherein forming the trace from the spans of the microservices comprises forming a binary vector for each trace, each binary vector having entries composed of binary values that represent whether a span is part of the trace or not.

3. The method of claim 1 wherein projecting binary vector representations of the traces onto the behavioral map in two-dimensional space comprises using t-distributed stochastic neighbor embedding to reduce the dimensionality of the binary vector of the traces to points in two-dimensions.

4. The method of claim 1 wherein the machine learning models comprises an XGBoost model for explanation of erroneous traces, the XGBoost model trained based on previously generated erroneous and normal traces for the distributed application.

5. The method of claim 1 wherein the machine learning models comprises an XGBoost model for detection of low latency and high latency traces, the XGBoost model trained based on low, normal, and high latencies of previously generated traces for the distributed application.

6. The method of claim 1 wherein the functionalities that enables the user to launch operations for investigating traces based on trace type comprises:
using density-based clustering to detect clusters of points in the behavioral map; and
displaying each cluster in the pane with a different shading or color in the GUI.

7. The method of claim 1 wherein displaying the behavioral map of in the GUI enables the user to launch the machine learning model to investigate performance problems comprises using the machine learning model to generate scores of spans that correspond to microservices with performance problems.

8. The method of claim 1 wherein displaying the behavioral map of in the GUI enables the user to launch the machine learning model to investigate performance problems comprises using the machine learning model to generate scores of spans that create low latency or high latency in the microservices.

9. A computer system for performing diagnostics of an application executing in a cloud infrastructure, the system comprising:
one or more processors;
one or more data-storage devices;
a display device; and
machine-readable instructions stored in the one or more data-storage devices that when executed using the one or more processors controls the system to perform the operations comprising:
collecting spans that represent operations performed by microservices of the application in response to requests for services executed by the application;
for each service executed by the application, forming a trace from the spans of the microservices that executed operations to provide the service;
projecting binary vector representations of the traces onto a behavioral map in two-dimensional space, the behavioral map having points that represent the traces in two dimensions; and
displaying a graphical user interface (“GUI”) on the display device, the GUI having a pane that displays the behavioral map and functionalities that enables a user to launch operations for investigating traces based on trace type and duration and launch machine learning models to investigate performance problems with microservices and latency of microservices.

10. The computer system of claim 9 wherein forming the trace from the spans of the microservices comprises forming a binary vector for each trace, each binary vector having entries composed of binary values that represent whether a span is part of the trace or not.

11. The computer system of claim 9 wherein projecting binary vector representations of the traces onto the behavioral map in two-dimensional space comprises using t-distributed stochastic neighbor embedding to reduce the dimensionality of the binary vector of the traces to points in two-dimensions.

12. The computer system of claim 9 wherein the machine learning models comprises an XGBoost model for explanation of erroneous traces, the XGBoost model trained based on previously generated erroneous and normal traces for the distributed application.

13. The computer system of claim 9 wherein the machine learning models comprises an XGBoost model for detection of low latency and high latency traces, the XGBoost model trained based on low, normal, and high latencies of previously generated traces for the distributed application.

14. The computer system of claim 9 wherein the functionalities that enables the user to launch operations for investigating traces based on trace type comprises:
using density-based clustering to detect clusters of points in the behavioral map; and
displaying each cluster in the pane with a different shading or color in the GUI.

15. The computer system of claim 9 wherein displaying the behavioral map of in the GUI enables the user to launch the machine learning model to investigate performance problems comprises using the machine learning model to generate scores of spans that correspond to microservices with performance problems.

16. The computer system of claim 9 wherein displaying the behavioral map of in the GUI enables the user to launch the machine learning model to investigate performance problems comprises using the machine learning model to generate scores of spans that create low latency or high latency in the microservices.

17. A non-transitory computer-readable medium encoded with machine-readable instructions that implement a method carried out by one or more processors of a computer system to perform the operations comprising:
collecting spans that represent operations performed by microservices of the application in response to requests for services executed by the application;
for each service executed by the application, forming a trace from the spans of the microservices that executed operations to provide the service;
projecting binary vector representations of the traces onto a behavioral map in two-dimensional space, the behavioral map having points that represent the traces in two dimensions; and
displaying a graphical user interface (“GUI”) on a display device, the GUI having a pane that displays the behavioral map and functionalities that enables a user to launch operations for investigating traces based on trace type and duration and launch machine learning models to investigate performance problems with microservices and latency of microservices.

18. The medium of claim 17 wherein forming the trace from the spans of the microservices comprises forming a binary vector for each trace, each binary vector having entries composed of binary values that represent whether a span is part of the trace or not.

19. The medium of claim 17 wherein projecting binary vector representations of the traces onto the behavioral map in two-dimensional space comprises using t-distributed stochastic neighbor embedding to reduce the dimensionality of the binary vector of the traces to points in two-dimensions.

20. The medium of claim 17 wherein the machine learning models comprises an XGBoost model for explanation of erroneous traces, the XGBoost model trained based on previously generated erroneous and normal traces for the distributed application.

21. The medium of claim 17 wherein the machine learning models comprises an XGBoost model for detection of low latency and high latency traces, the XGBoost model trained based on low, normal, and high latencies of previously generated traces for the distributed application.

22. The medium of claim 17 wherein the functionalities that enables the user to launch operations for investigating traces based on trace type comprises:
using density-based clustering to detect clusters of points in the behavioral map; and
displaying each cluster in the pane with a different shading or color in the GUI.

23. The medium of claim 17 wherein displaying the behavioral map of in the GUI enables the user to launch the machine learning model to investigate performance problems comprises using the machine learning model to generate scores of spans that correspond to microservices with performance problems.

24. The medium of claim 17 wherein displaying the behavioral map of in the GUI enables the user to launch the machine learning model to investigate performance problems comprises using the machine learning model to generate scores of spans that create low latency or high latency in the microservices.
